(19) United States
(12) Patent Application Publication
(10) Pub. No.: US 2009/0197780 A1
(43) Pub. Date: Aug. 6, 2009

(54) Ultrafine Grinding of Soft Materials

(76) Inventors: Jimmie D. Weaver, Duncan, OK (US); Steven Wilson, Loco, OK (US); Trinidad Munoz, Dallas, TX (US); Paul Lord, Duncan, OK (US); Kirk L. Schreiner, Duncan, OK (US)

Correspondence Address: ROBERT A. KENT, P.O. BOX 1431, DUNCAN, OK, 73536, US

(21) Appl. No.: 12/361,244

(22) Filed: Jan. 28, 2009

Related U.S. Application Data
(60) Provisional application No. 61/025,602, filed on Feb. 1, 2008.

(51) Int. Cl. C09K 8/92; B02C 11/08; B01F 15/06; B02C 23/00

(52) U.S. Cl. 507/204; 507/211; 507/219; 507/230; 366/144; 241/65

(57) ABSTRACT

Compositions and methods pertaining to the ultrafine grinding of soft materials are disclosed. In one embodiment, a method comprises the step of mixing a soft material with an additive to form a mixture. The method further comprises raising the temperature of the mixture to at least the glass transition temperature of the soft material. The method further comprises cooling the temperature of the mixture. The method further comprises grinding the mixture to form ultrafine particles that comprise at least a portion of the soft material.

### BACKGROUND

The present invention relates to compositions and methods pertaining to the ultrafine grinding of soft materials to form ultrafine particles and the usage thereof, and more particularly, in certain embodiments, the present invention provides methods of forming and using ultrafine polylactide (“PLA”) particles.

In some instances, processes for grinding soft materials may present difficulties in achieving very small particle sizes without damaging the materials being ground. For instance, mechanical grinding may activate brittle fractures of the material. Below a material-dependent size, the fracture-generating flaws may be so small that they cannot be readily activated. Below this size, comminution is thought to be difficult. Therefore, in soft materials, the stressed particles may be only deformed or formed to larger aggregates, but not further comminuted. In methods using a grinding wheel, the grinding surface portion of the grinding wheel may become clogged with the soft material. The friction of the mechanical grinding also may heat the grinding surface above the melting point of the soft material, resulting in melting and smearing of the soft material. Such clogging and/or smearing may require frequent finishing or dressing of the grinding wheel, thereby increasing the procedure time and expense.

Other examples of grinding methods include high shear dispersion grinding, emulsion processing, and the use of solid additives with dry grinding. These similarly have drawbacks. For instance, although high shear dispersion grinding processes have been demonstrated on commercially sized equipment, these processes are generally limited to producing particles larger than about 300 μm. Emulsion processes may be suitable for producing particles smaller than 150 μm, but these processes can present process control and analytical challenges.

One example of a soft material is PLA. PLA particles can be useful for a variety of applications, including as fluid loss control particles, as components of drilling fluids or cements, or as delayed-acid-release components of a fluid. Smaller PLA particles can often provide better absorption and quicker reaction times than larger particles. However, PLA is a thermoplastic. To form relatively small PLA particles, PLA is typically cryogenically ground to prevent melting and smearing due, inter alias to the heat generated during the mechanical grinding process. Cryogenic equipment and procedures may add costs and complexities to the manufacturing process. Moreover, cryogrinding generally is thought to be limited to forming PLA particles that are about 150 μm or larger in size.

Another example of a soft material is guar. Smaller particles of guar are desirable in certain applications, as they tend to hydrate more quickly than larger particles. However, attempts to conventionally grind guar to ultrafine particle size may result in undesirable complications such as charring of the guar. This can be particularly problematic when guar is used in cool water operation of dry gel blending equipment.

### SUMMARY

The present invention relates to compositions and methods pertaining to the ultrafine grinding of soft materials to form ultrafine particles and the usage thereof, and more particularly, in certain embodiments, the present invention provides methods of forming and using ultrafine polylactide (“PLA”) particles.

One embodiment of the present invention provides a method of forming and using ultrafine particles. The method comprises the step of mixing a soft material with an additive to form a mixture. The method further comprises the step of raising the temperature of the mixture to at least the glass transition temperature of the soft material. The method further comprises the step of cooling the temperature of the mixture. The method further comprises grinding the mixture to form ultrafine particles that comprise at least a portion of the soft material.

In another embodiment, an additional method of forming and using ultrafine particles is provided. The method comprises the step of providing a soft material. The method further comprises the step of raising the temperature of the soft material to at least the glass transition temperature of the soft material. The method further comprises the step of cooling the temperature of the soft material while stressing the soft material. The method further comprises the step of grinding the soft material to form ultrafine particles.

Yet another embodiment provides a method of forming and using ultrafine particles. The method comprises the step of mixing a soft material with a treatment additive to form a mixture. The method further comprises raising the temperature of the mixture to at least the glass transition temperature of the soft material. The method further comprises cooling the temperature of the mixture. The method further comprises grinding the mixture to form ultrafine particles that comprise at least a portion of the soft material, whereby at least a portion of the treatment additive is at least partially coated by some portion of the soft material.

The features and advantages of the present invention will be readily apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 illustrates the particle size distribution for an example combination of polylactide and sodium chloride crystals.

FIG. 2 illustrates the particle size distribution for example combinations of polylactide and sodium chloride crystals in an aqueous medium.

FIG. 3 illustrates the particle size distribution for example combinations of polylactide and sodium chloride crystals.

FIG. 4 illustrates the particle size distribution for example combinations of amorphous polylactide and sodium chloride crystals in an aqueous medium.

FIG. 5 illustrates the particle size distribution for example combinations of amorphous polylactide and sodium chloride crystals.

FIG. 6 illustrates the particle size distribution for example combinations of crystalline polylactide and sodium chloride crystals in an aqueous medium.

FIG. 7 illustrates the particle size distribution for example combinations of crystalline polylactide and sodium chloride crystals.

FIG. 8 illustrates the particle size distribution for example combinations of crystalline polylactide and sodium chloride crystals, and for example combinations of amorphous polylactide and sodium chloride crystals, each in an aqueous medium.

FIG. 9 illustrates the particle size distribution for example combinations of crystalline polylactide and sodium chloride crystals, and for example combinations of amorphous polylactide and sodium chloride crystals.

FIG. 10 illustrates differential scanning calorimetry thermographs for example treatments of amorphous polylactide.

FIG. 11 illustrates differential scanning calorimetry thermographs for example treatments of crystalline polylactide.

### DESCRIPTION OF PREFERRED EMBODIMENTS

The present invention relates to compositions and methods pertaining to the ultrafine grinding of soft materials to form ultrafine particles and the usage thereof, and more particularly, in certain embodiments, the present invention provides methods of forming and using ultrafine polylactide (“PLA”) particles.

As used here, the term “ultrafine” generally refers to resultant particle sizes from about 0.10 μm to about 200 μm. In some embodiments, “ultrafine” refers to resultant particle sizes from about 0.25 μm to about 150 μm. In some embodiments, “ultrafine” refers to resultant particle sizes from about 0.75 μm to about 150 μm, while in other embodiments, “ultrafine” refers to resultant particle sizes below about 0.50 μm. Such ultrafine particles may present advantages in a variety of applications, including, but not limited to, oil and gas drilling and production technology, surface finish techniques such as powder coating, and the production of packaging materials.

In some embodiments of this invention, ultrafine grinding of a soft material may be achieved by mixing the soft material with one or more additives, raising the temperature of the mixture to at least the glass transition temperature of the soft material, cooling the mixture at a specified rate, and then grinding the cooled mixture by any suitable means to produce ultrafine particles. Optionally, the mixture may be stressed while heating and/or cooling. In some embodiments, one or more additives may be combined with the soft material while the temperature is being raised and/or during cooling.

In another embodiment of this invention, ultrafine grinding of a soft material may be achieved by raising the temperature of the soft material to its glass transition temperature, cooling the soft material at a specified rate while stressing the soft material, and then grinding the cooled soft material by any suitable means to produce ultrafine particles. Optionally, the mixture may be stressed while heating. In some embodiments, one or more additives may be combined with the soft material prior to or while the temperature is being raised, and/or during cooling.

The optional step of stressing the mixture or soft material may be generally performed according to any suitable means which results in increased molecular alignment. In some embodiments, stressing may be performed by rolling, tumbling, spinning, stretching, pulling, extruding, centrifugal-blowing, or extrusion blow molding.

In some embodiments, commercially available extruders may be used to raise the temperature while stressing the material or mixture, according to one aspect of the invention. For example, Horizontal Extruders may be suitable, and are commercially available from Thermoplastics Engineer Corporation of Leominster, Mass. Other extruders known in the art also may be suitable.

The soft material and/or mixture of soft material and additives may be cooled by a variety of techniques and rates according to the methods of the present invention. The cooling rate may depend upon the degree of organization of the material in its melt state and the crystallinity of the material in its solid state. A person of ordinary skill in the art with the aid of this disclosure may recognize how to use the differential scanning calorimetry (“DSC”) thermograph of the material to determine suitable cooling rates. Generally, suitable cooling will result in a material which is more brittle than it was prior to heating and cooling. In some embodiments of this invention, the rate of cooling may be relatively long, referred to herein as “slow cooling.” In other embodiments of this invention, the rate of cooling may be relatively quick, referred to herein as “quench cooling.” Slow cooling may require from about 5 hours to about 30 hours to reduce the temperature from at least the glass transition temperature of the soft material to ambient temperature. In some embodiments, slow cooling may require less than 5 hours. In some embodiments, the material may be stressed while undergoing slow cooling. Quench cooling may require from about 5 seconds to about 30 minutes to likewise reduce the temperature. In some embodiments, quench cooling may require from about 0.1 seconds to about 10 seconds. Quench cooling may optionally be combined with or followed by hydraulic extrusion.

Grinding of the cooled mixture or soft material may be performed according to any suitable means. As used herein, the term “grinding” refers to any chemical or mechanical process which may reduce the particle size of a material to a desired size. In some embodiments, grinding may be performed by utilizing a cyclone sample mill, such as those commercially available from UDY Corporation of Fort Collins, Colo. In some embodiments, grinding may be performed by utilizing a hammer mill. Other suitable grinding devices may include, but are not limited to, a ball mill, a rod mill, a semi-autogenous grinding mill, an autogenous mill, a pebble mill, a buhrstone mill, and high pressure grinding rolls. In some embodiments, grinding may occur as a multi-step process, wherein coarse grinding precedes finer grinding.

As used herein, “soft materials” may refer to those materials that are not likely to fracture easily when exposed to blunt force, but rather are more likely to smear, melt, or deform. In some embodiments, “soft materials” refers to materials with a Mohs hardness of about 1 to about 4. In some embodiments, “soft materials” refers to materials with a Mohs hardness of about 0.5 to 2. In some embodiments, “soft materials” refers to materials with a Mohs hardness of less than about 1. In some embodiments, “soft materials” refers to materials with an Ultimate Strength of 10-100 megapascals (“MPa”). In some embodiments, “soft materials” refers to materials with an Ultimate Strength of 5-50 MPa. In some embodiments, “soft materials” refers to materials with an Ultimate Strength of 1-10 MPa. In some embodiments, “soft materials” refers to materials with an Ultimate Strength of less than 1 MPa. As used herein, “Ultimate Strength” refers to the maximum stress a material can withstand when subjected to tension, compression or shearing as measured by the ASTM D638 test method.

Soft materials suitable for this invention may include, but should not be limited to, PLA, guar, aliphatic polyesters, degradable materials, thermoplastic materials such as polyethylene or polypropylene, vinyl polymers, polyvinyl alcohol, polysaccharides, cork, rubber, fiberboard, and the like.

The particular soft material chosen may dictate the particular parameters used in the associated methods. For instance, the rate at which the temperature of the material or mixture is raised may vary by the characteristics of the soft material. In certain embodiments, the temperature is elevated for a sufficient time to allow for substantial alignment of the molecules of the soft material. In one embodiment, the material may be exposed to a maximum temperature of about 300° F. to about 400° F. over a period of from about 1 hour to about 10 hours. The maximum temperature may vary with the glass transition temperature and melting point of the soft material (and thus will depend at least on the characteristics of the soft material). In some embodiments, the temperature may be elevated for less than 1 hour. While cooling, the material or mixture may be subjected to stress, which may stretch and/or align the molecules of the soft material. The stress may act, inter alia, to change the brittleness of the soft material. Stress also may be applied while the temperature is being raised. This may be helpful when the maximum temperature approaches, but does not reach, the melting point of the soft material.

Certain degradable materials may be utilized as a suitable the soft material in the methods of the present invention. In certain embodiments of the present invention, the degradable material may be a degradable polymer. The terms “degradation” or “degradable” refer to both the two relatively extreme cases of hydrolytic degradation that the degradable material may undergo, e.g. heterogeneous (or bulk erosion) and homogeneous (or surface erosion), and any stage of degradation in between these two. This degradation can be a result of, inter alia, a chemical or thermal reaction, or a reaction induced by radiation. The terms “polymer” or “polymers” as used herein do not imply any particular degree of polymerization; for instance, oligomers are encompassed within this definition.

A polymer is considered to be “degradable” herein if it is capable of undergoing an irreversible degradation when used in an appropriate applications, e.g. in a well bore. The term “irreversible” as used herein means that the degradable material should degrade in situ but should not recrystallize or reconsolidate in situ after degradation.

Suitable examples of degradable polymers that may be used in accordance with the present invention include, but are not limited to, those described in the publication of Advances in Polymer Science, Vol. 157 entitled “Degradable Aliphatic Polyesters,” edited by A. C. Albertsson, pages 1-138. Specific examples include homopolymers, random, block, graft, and star- and hyper-branched aliphatic polyesters. Such suitable polymers may be prepared by polycondensation reactions, ring-opening polymerizations, free radical polymerizations, anionic polymerizations, carbocationic polymerizations, coordinative ring-opening polymerizations, as well as by any other suitable process. Examples of suitable degradable polymers that may be used in conjunction with the methods of this invention include, but are not limited to, aliphatic polyesters; poly(lactides); poly(glycolides); poly(ε-caprolactones); poly(hydroxy ester ethers); poly(hydroxybutyrates); poly(anhydrides); polycarbonates; poly(orthoesters); poly(amino acids); poly(ethylene oxides); poly(phosphazenes); poly ether esters, polyester amides, polyamides, and copolymers or blends of any of these degradable polymers, and derivatives of these degradable polymers. The term “copolymer” as used herein is not limited to the combination of two polymers, but includes any combination of polymers, e.g. terpolymers and the like. As referred to herein, the term “derivative” is defined herein to include any compound that is made from one of the listed compounds, for example, by replacing one atom in the base compound with another atom or group of atoms. Of these suitable polymers, aliphatic polyesters such as poly(lactic acid), poly(anhydrides), poly(orthoesters), and poly(lactide)-co-poly(glycolide) copolymers are preferred. Poly(lactic acid) is especially preferred. Poly(orthoesters) also may be preferred. Other degradable polymers that are subject to hydrolytic degradation also may be suitable. One's choice may depend on the particular application or use and the conditions involved. Other guidelines to consider include the degradation products that result, the time for required for the requisite degree of degradation, and the desired result of the degradation (e.g., voids).

Suitable aliphatic polyesters have the general formula of repeating units shown below:

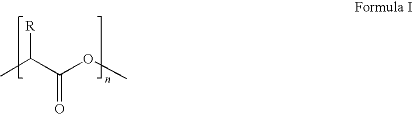

where n is an integer between 75 and 10,000 and R is selected from the group consisting of hydrogen, alkyl, aryl, alkylaryl, acetyl, heteroatoms, and mixtures thereof In certain embodiments of the present invention wherein an aliphatic polyester is used, the aliphatic polyester may be poly(lactide). Poly(lactide) is synthesized either from lactic acid by a condensation reaction or, more commonly, by ring-opening polymerization of cyclic lactide monomer. Since both lactic acid and lactide can achieve the same repeating unit, the general term poly(lactic acid) as used herein refers to writ of formula I without any limitation as to how the polymer was made (e.g., from lactides, lactic acid, or oligomers), and without reference to the degree of polymerization or level of plasticization.

The lactide monomer exists generally in three different forms: two stereoisomers (L- and D-lactide) and racemic D,L-lactide (meso-lactide). The oligomers of lactic acid and the oligomers of lactide are defined by the formula:

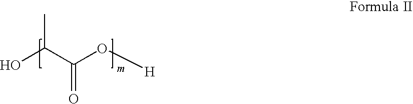

where m is an integer in the range of from greater than or equal to about 2 to less than or equal to about 75. In certain embodiments, m may be an integer in the range of from greater than or equal to about 2 to less than or equal to about 10. These limits may correspond to number average molecular weights below about 5,400 and below about 720, respectively. The chirality of the lactide units provides a means to adjust, inter alias degradation rates, as well as physical and mechanical properties. Poly(L-lactide), for instance, is a semicrystalline polymer with a relatively slow hydrolysis rate. This could be desirable in applications or uses of the present invention in which a slower degradation of the degradable material is desired. Poly(D,L-lactide) may be a more amorphous polymer with a resultant faster hydrolysis rate. This may be suitable for other applications or uses in which a more rapid degradation may be appropriate. The stereoisomers of lactic acid may be used individually, or may be combined in accordance with the present invention. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified by blending high and low molecular weight polylactide or by blending polylactide with other polyesters. In embodiments wherein polylactide is used as the degradable material, certain preferred embodiments employ a mixture of the D and L stereoisomers, designed so as to provide a desired degradation time and/or rate. Examples of suitable sources of degradable material are poly(lactic acids) that are commercially available from NatureWorks® of Minnetonka, Minn., under the trade names “3001D” and “4060D.”

Aliphatic polyesters useful in the present invention may be prepared by substantially any of the conventionally known manufacturing methods such as those described in U.S. Pat. Nos. 6,323,307; 5,216,050; 4,387,769; 3,912,692; and 2,703,316, the relevant disclosures of which are incorporated herein by reference.

Polyanhydrides are another type of degradable polymer that may be suitable for use in the present invention. Examples of suitable polyanhydrides include poly(adipic anhydride), poly(suberic anhydride), poly(sebacic anhydride), and poly(dodecanedioic anhydride). Other suitable examples include, but are not limited to, poly(maleic anhydride) and poly(benzoic anhydride).

The physical properties of degradable polymers may depend on several factors including, but not limited to, the composition of the repeat units, flexibility of the chain, presence of polar groups, molecular mass, degree of branching, crystallinity, and orientation. For example, short chain branches may reduce the degree of crystallinity of polymers while long chain branches may lower the melt viscosity and may impart, inter alia, extensional viscosity with tension-stiffening behavior. The properties of the material utilized further may be tailored by blending, and copolymerizing it with another polymer, or by a change in the macromolecular architecture (e.g. hyper-branched polymers, star-shaped, or dendrimers, and the like). The properties of any such suitable degradable polymers (e.g. hydrophobicity, hydrophilicity, rate of degradation, and the like) can be tailored by introducing select functional groups along the polymer chains. For example, poly(phenyllactide) will degrade at about one-fifth of the rate of racemic poly(lactide) at a pH of 7.4 at 55° C. One of ordinary skill in the art, with the benefit of this disclosure, will be able to determine the appropriate functional groups to introduce to the polymer chains to achieve the desired physical properties of the degradable polymers.

Whichever degradable material is used in the present invention, the degradable material may have any shape, including, but not limited to, particles having the physical shape of platelets, shavings, flakes, ribbons, rods, strips, spheroids, toroids, pellets, tablets, or any other physical shape. In certain embodiments of the present invention, the degradable material used may comprise a mixture of fibers and spherical particles. One of ordinary skill in the art, with the benefit of this disclosure, will recognize the specific degradable material that may be used in accordance with the present invention, and the preferred size and shape for a given application or use.

In some embodiments, the one or more additives may be a solid. For example, the soft material may be mixed with a solid additive prior to grinding. Without limiting the invention to a particular theory or mechanism of action, it is believed that such use of some solid additives may provide a heat sink for the excess energy given off during the grinding process and/or an abrasive action to help in the milling operation.

Solid additives suitable for use in the present invention may include any suitable inorganic materials which do not char or melt when ground. In some embodiments, relatively inexpensive solid additives may be preferred. Suitable solid additives may include, but are not limited to, quartz, potassium chloride, calcium chloride, magnesium chloride, sodium persulfate, sugar, clay, sand, calcium carbonate, sodium bicarbonate, sodium bisulfate, potassium hydroxide, sodium hydroxide, coated particulates, and mixtures thereof In one embodiment of this invention, the solid additive may be sodium chloride (“NaCl”). In subsequent application or use of the ultrafine particles, such as in oilfield operations, any remaining additive in the particle mixture may not interfere with normal operations, and may not need to be separated from the ultrafine particles of soft material. This may be particularly advantageous, in that the mixture of PLA and NaCl particles would occupy a greater volume without requiring additional PLA. In other embodiments addressing other applications or uses, the additive may need to be chemically or mechanically separated from the ultrafine particles of soft material prior to application or use. Solid additives may be used in any amount which provides sufficient improvement in grinding performance, from about 1% by weight of the mixture to about 99% by weight of the mixture. In some embodiments, the solid additives may comprise about 50% by weight of the mixture. As would be understood by one of ordinary skill in the art with the benefit of this disclosure, soft materials which are more difficult to grind may indicate a higher percentage of solid additives. Alternatively, some embodiments may present application parameters for which a lower percentage of solid additives may be appropriate. For example, when the soft material is PLA, and when the application or use requires longer time periods for degradation of the PLA, a lower ratio of solid additive may be appropriate.

Additives suitable for use in the present invention also may include treatment additives. The term “treatment additive” does not imply any particular action by the chemical or a component thereof A “treatment additive” may be any component that is to be placed downhole to perform a desired function, e.g., act upon a portion of the subterranean formation, a tool, or a composition located downhole. Any treatment additive that is useful downhole and that does not adversely react with the soft material or other additives may be used as a treatment additive in the present invention. Suitable treatment additives may include, but are not limited to, sodium persulfate, chelating agents (e.g., EDTA, citric acid, polyaspartic acid,), scale inhibitors, gel breakers, dispersants, paraffin inhibitors, wax inhibitors, corrosion inhibitors, de-emulsifiers, foaming agents, tracers, defoamers, delinkers, crosslinkers, surfactants, derivatives and/or combinations thereof For instance, a treatment additive may be a boron-based crosslinking agent that will be used to crosslink a gelling agent downhole. Treatment additives may be used in any amount which provides appropriate grinding and/or application or use results, from about 1% by weight of the mixture to about 99% by weight of the mixture. In some embodiments, the treatment additives may comprise about 50% by weight of the mixture. As would be understood by one of ordinary skill in the art with the benefit of this disclosure, when the treatment additive improves grinding performance, a higher ratio of treatment additive may be appropriate. Some embodiments may present grinding or application parameters which indicate a lower ratio of treatment additives. For example, when the soft material is PLA, and when the application or use requires longer time periods for degradation of the PLA, a lower ratio of treatment additive may be appropriate.

In some embodiments, the additive may be any mineral or inorganic filler material which, when exposed to environmental conditions such as water, may change the pH, thereby affecting the PLA. This may include oxidizers and inorganic acids.

In some embodiments of the present invention, the one or more additives may be a liquid or gaseous additive. In one embodiment, wherein the soft material may be PLA, the additive may be air or carbon dioxide (“CO₂”). The air or carbon dioxide may be blown through the PLA during the cooling process. After cooling, the resulting mixture may be a PLA foam. Following grinding, the ultrafine PLA particles may exhibit a honeycomb structure throughout the volume of the particle. A person of ordinary skill in the art, with the benefit of this disclosure, would recognize that a variety of soft materials could be used with liquid or gaseous additives according to the methods of this invention to create ultrafine particles which exhibit a honeycomb structure.

The ultrafine particles of the present invention may be used in any subterranean operation known in the art wherein small particles may be employed. Examples of such subterranean operations include but are not limited to drilling, cementing, completion, fracturing, stimulating, and clean-up. Such ultrafine particles may be used as bridging agents, fluid loss control agents, breakers, proppant particulates, corrosion inhibitors, chelating agents, filter cake clean-up agents, or slow release acids. In some embodiments, the methods of the present invention may produce ultrafine particles which comprise a coated additive that is at least partially coated by some portion of the soft material. Where the soft material comprises a degradable material, such coated additives may be advantageous, among other reasons, for their ability to slowly release a treatment additive into an environment in which they are placed.

The ultrafine particles may be utilized in subsequent applications or uses, for example, as a dry powder and/or in a liquid slurry. In some instances, free flow agents and/or anti-caking agents may be added to the ultrafine particles. For example, free flow agents may include compounds such as sodium silicates, talc, clays, desiccants, and silicas. In some embodiments, the free flow agents and/or anti-caking agents may be composed of the same material as the aforementioned additives.

In some embodiments, one or more of the additives may be separated or removed from the mixture comprising the ultrafine particles prior to, during, or subsequent to application or use. For example, some additives may pose environmental or safety concerns. Generally, such additives may be removed by any commonly practiced separation and removal technique, including both mechanical and chemical separation and/or removal. Additives may be removed as a final step of production of the ultrafine particles, as a first step of preparation for application or use of the ultrafine particles, or as a final, remedial step following application or use of the ultrafine particles.

To facilitate a better understanding of the present invention, the following examples of certain aspects of some embodiments are given. In no way should the following examples be read to limit, or define, the entire scope of the invention.

### EXAMPLES

### Example I

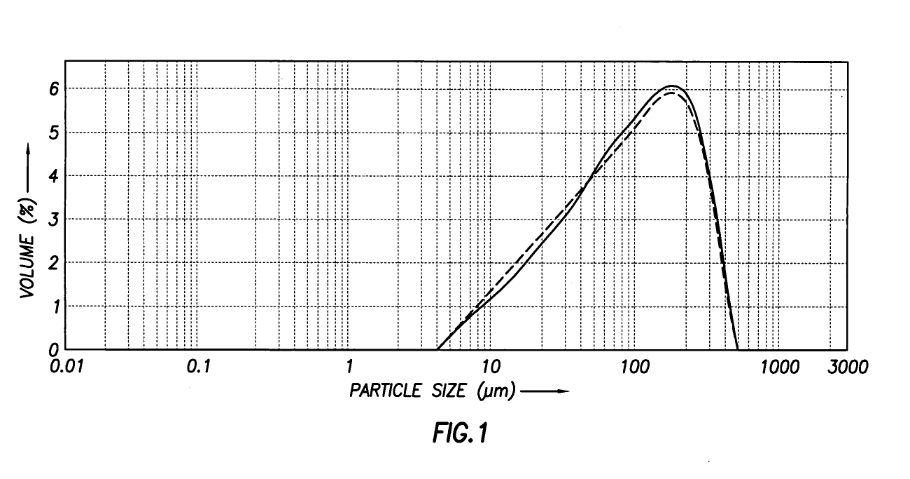

As an example, polylactide (“PLA”) and sodium chloride (“NaCl”) crystals are combined, heated until the PLA melts, and combined by stirring. The stirring is continued while the mixture is cooled. In this example experiment, resultant sizes are about ⅛″-¼″ in diameter. This resulting material is about 50% PLA. The particle size distribution (“PSD”) for the resulting grind is shown in FIG. 1.

### Example II

Sample jars are prepared in order to heat the following mixtures:

1. 100%PLA(Blank) 2. 90%PLA+10% NaCl 3. 75% PLA+25% NaCl 4. 50% PLA+50% NaCl

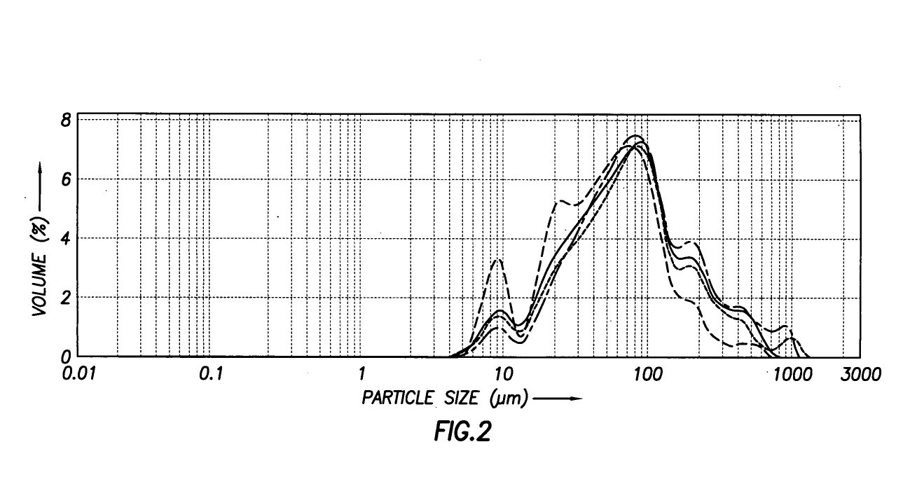

A roller oven is used to heat the mixtures to about 300° F. for about 15 hours while keeping the PLA and salt stirring. The resulting PLA/NaCl melts are then cooled slowly while stirring. The cooled glassy mixtures are then removed from the jars and can be ground by a cyclone sample mill. Particle size analysis is performed on the samples by two methods. The first method involves determining the PSD in an aqueous medium that would allow the salt contained in the above mixtures to dissolve leaving behind the PLA for particle size distribution measurements. The second method involves measuring the PSD of the dry powder alone. The resulting PSD charts are shown in FIGS. 2 and 3 for both measurement methods. As indicated by this data, in certain embodiments, melting the PLA material combined with the slow cooling makes the PLA brittle enough for simple mechanical grinding without the need for additional solid additives. In contrast, grinding of PLA that has not been melted and then slow cooled produces smeared material when ground.

### Example III

A series of additional tests are conducted with PLA containing varying amounts of NaCl. The first series of tests involves the use of amorphous PLA (“APLA”). Sample jars are prepared with APLA as shown:
1. 100% APLA (Blank) Heat Treated/Stressed (jar was rolled)/Slow Cooled (while rolling)
2. 90% APLA+10% NaCl, Heat Treated/Stressed (jar was rolled)/Slow Cooled (while rolling)
3. 75% APLA+25% NaCl, Heat Treated/Stressed (jar was rolled)/Slow Cooled (while rolling)
4. 50% APLA+50% NaCl, Heat Treated/Stressed (jar was rolled)/Slow Cooled (while rolling)

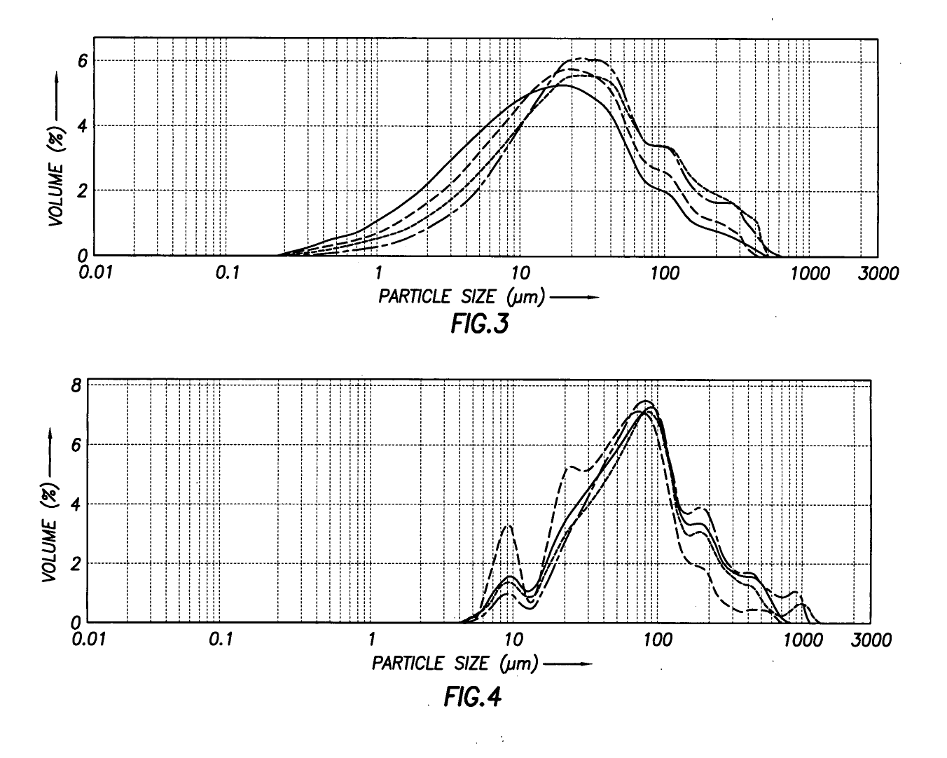

A roller oven is used to heat the mixtures to about 300° F. for about 15 hours while keeping the APLA and salt stirring. The resulting APLA/NaCl melts are then cooled slowly while stirring. The cooled glassy mixtures are then removed from the jars and ground by cyclone sample mill using a 0.25 micron screen. PSD analysis is performed on the samples by two methods. The first method involves an aqueous medium which would allow the salt contained in the above mixtures to dissolve leaving behind the APLA for PSD measurements. The second method involves measuring the PSD of the dry powder alone. The resulting PSD charts for both measurement methods are given in FIGS. 4 and 5. As illustrated, there is very little difference in the median particle size (“D50”) between samples and measuring methods. As indicated by this data, in some embodiments, simply melting the APLA material combined with stress (i.e., rolling the jars) and slow cooling makes the APLA brittle enough for simple mechanical grinding. In contrast grinding of APLA that has not been melted/stressed and then slow cooled produces smeared material when ground.

### Example IV

A series of additional tests are conducted using crystalline PLA (“CPLA”). A roller oven is used to heat the mixtures to about 400° F. for about 15 hours with each jar treated as follows:

1. CPLA Heat Treated/Stressed (jar was rolled)/Slow Cooled (while rolling).

2. CPLA Heat Treated/Stressed (jar was rolled)/Quench cooled (with water).

3. CPLA Heat Treated/No Stress (Static)/Slow Cooled (static).

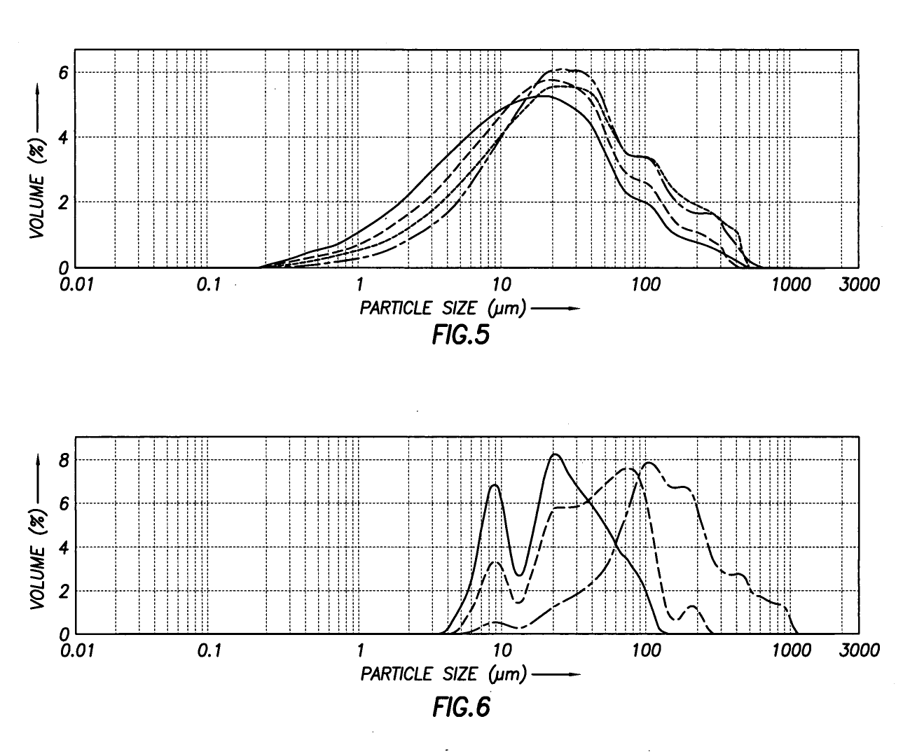

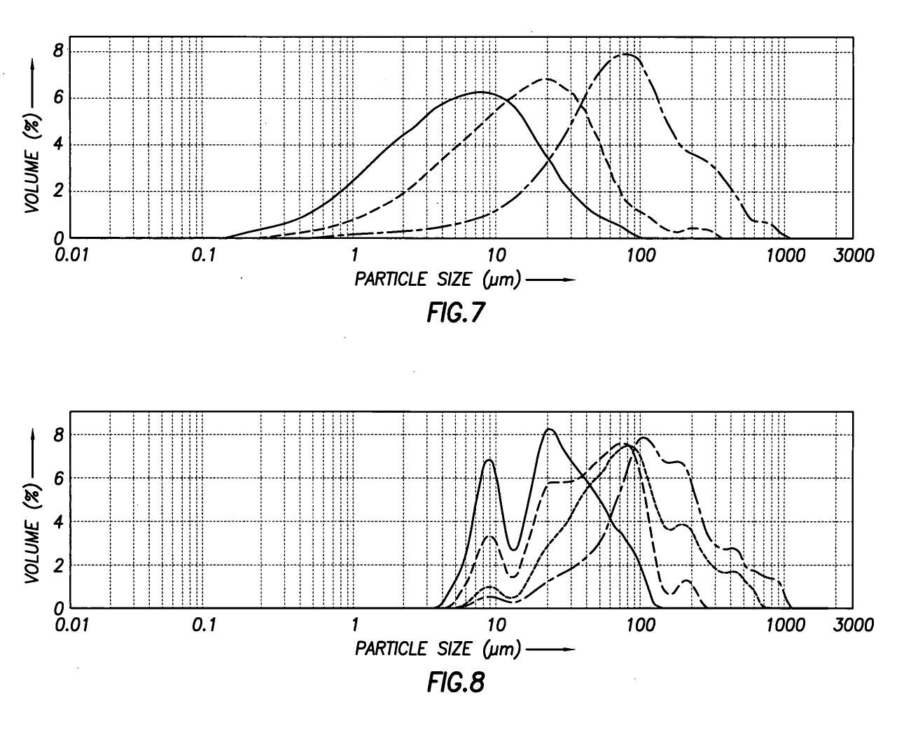

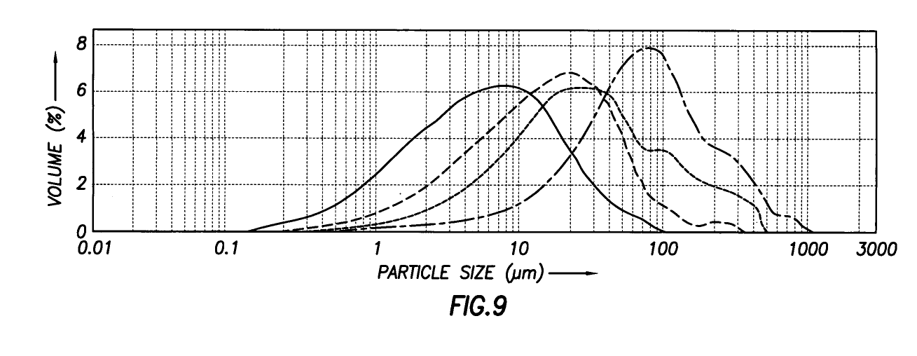

The cooled glassy mixtures are then removed from the vessels and ground by cyclone sample mill using a 0.25 micron screen. PSD analysis is performed on the samples by two methods. The first method involves an aqueous medium which would allow the salt contained in the above mixtures to dissolve leaving behind the CPLA for PSD measurements. The second method involves measuring the PSD of the dry powder alone. The resulting PSD data for both measurement methods is presented in FIGS. 6 and 7. PSD analysis performed via an aqueous medium in FIG. 6 shows multimodal distributions for the above heat treatments. This data suggests that the “Heat Treated/Stressed (jar was rolled)/Slow Cooled (while rolling)” method yields the smallest CPLA particles. This is better seen in FIG. 7, illustrating the PSD for the dry method of measuring. It should also be noted that the CPLA material “Heat Treated/No Stress (Static)/Slow Cooled (static)” shows the largest PSD in FIGS. 6 and 7. This material is also difficult to grind using the cyclone sample mill and does not appear as glassy as the other two treatment methods listed above. For comparative purposes, FIGS. 8 and 9 show the PSD analysis overlays of CPLA and APLA using the treatment methods above. As indicated by this data, in certain embodiments, simply melting the PLA material combined with stress (i.e., rolling the jars) and slow cooling makes the PLA brittle enough for simple mechanical grinding. In contrast grinding of PLA that has not been stressed produces larger particles and does not grind as easy.

### EXAMPLE V

The heat treated samples are analyzed by differential scanning calorimetry (“DSC”) to examine any changes in glass transition temperature (“Tg”), crystallization peak temperature (“Tc”), and melting temperature (“Tm”) compared to the starting parent material. PLA may be commonly produced by the ring open polymerization (“ROP”) of lactide.

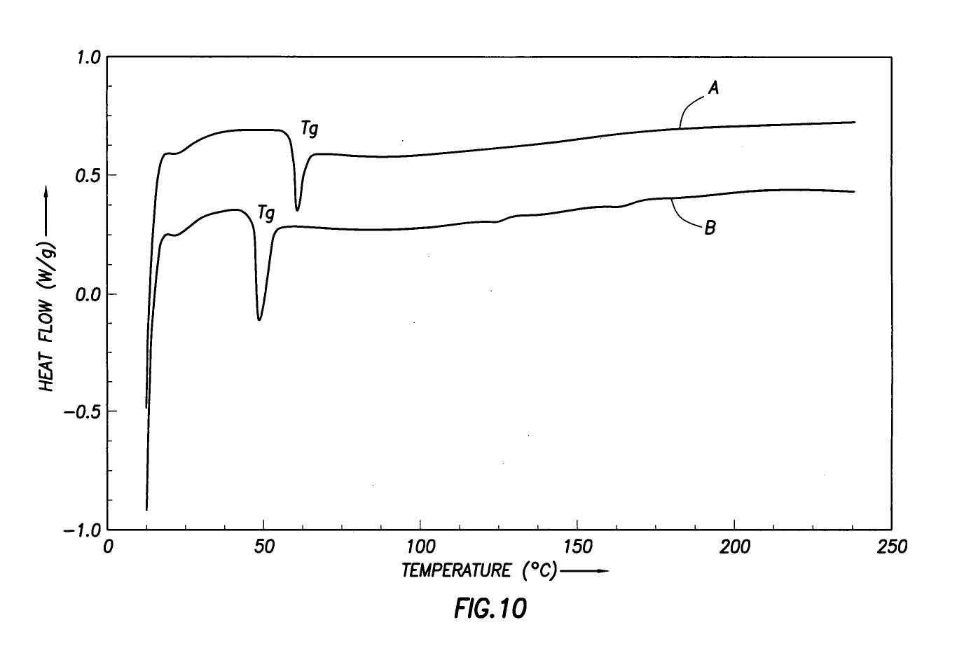

As shown in FIG. 10A, the DSC thermograph for the supplied APLA shows a T_{g} around 60° C. This material is subjected to a heat treatment in a roller oven to about 400° F. for about 15 hours and slowed cooled while rolling in the oven. The resulting DSC thermograph is observed in FIG. 10B. A depressed T_{g} is observed around 50° C. for the heat treated sample.

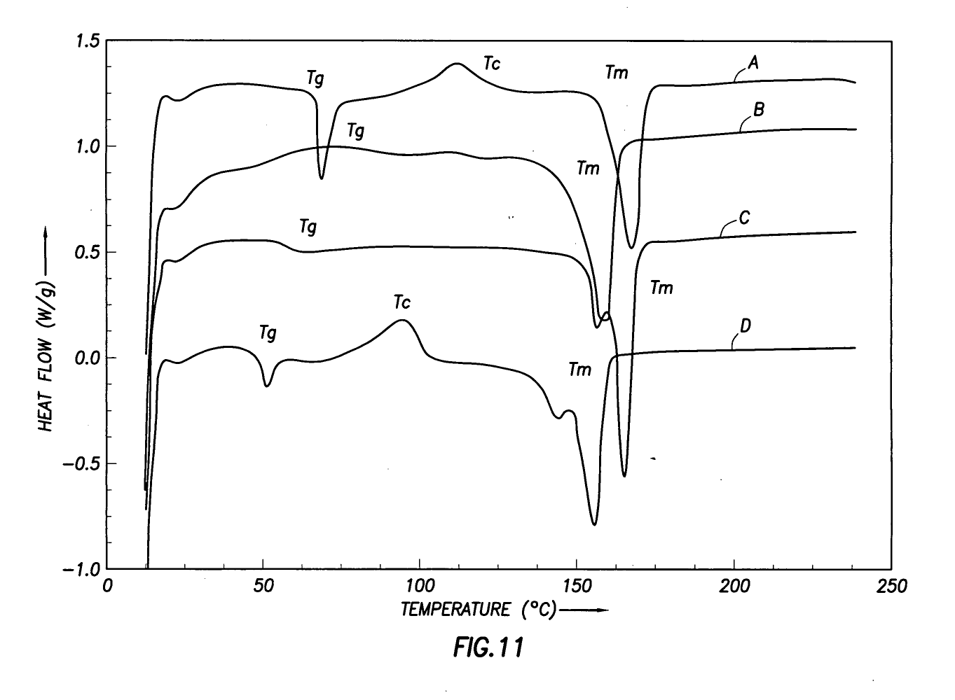

As shown in FIG. 1A, the DSC thermograph for the supplied CPLA shows three distinct thermal transitions. T_{g} has an onset of about 58° C. T_{c} peak forms around 120° C. The peak related to the Tₘ may be observed around 170° C. This material is subjected to a heat treatment in a roller oven to about 400° F. for about 15 hours and slowed cooled while rolling in the oven. The resulting DSC thermograph is observed in FIG. 11B. The elimination of the T_{c} peak is evidenced. As illustrated by this data, in some embodiments, the onset T_{g} temperature may increase slightly and may be weaker. The CPLA sample is heat treated and slow cooled but not oven rolled (i.e. stressed) during each of these steps. The resultant thermal profile is shown in FIG. 11C. Once again, the elimination of the T_{c} peak is seen. The T_{g} also may be weaker. Also present in the illustrated thermal profile are one minor and major Tₘ peaks. FIG. 11D shows a DSC thermograph of CPLA that has been subjected to a heat treatment in a roller oven to about 400° F. for about 15 hours and then quickly cooled by quenching with water. In this thermograph, a depressed T_{g} and a depressed Tₘ having a minor and major peak may be observed. Similarly, the presence of a T_{c} may be observed.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Moreover, the indefinite articles “a” or “an,” as used in the claims, are defined herein to mean one or more than one of the element that it introduces. Also, the terms in the claims have their plain, ordinary meaning unless otherwise explicitly and clearly defined by the patentee.

If there is any conflict in the usages of a word or term in this specification and one or more patent or other documents that may be incorporated herein by reference, the definitions that are consistent with this specification should be adopted for the purposes of understanding this invention.

What is claimed is:

1. A method comprising:
mixing a soft material with an additive to form a mixture;
raising the temperature of the mixture to at least the glass transition temperature of the soft material;
cooling the temperature of the mixture; and
grinding the mixture to form ultrafine particles that comprise at least a portion of the soft material.

2. The method of claim 1, further comprising stressing the mixture during the step of raising the temperature of the soft material to at least the glass transition temperature of the soft material.

3. The method of claim 1, further comprising stressing the mixture during the step of cooling the temperature of the mixture.

4. The method of claim 1, further comprising removing at least a portion of the additive from the ultrafine particles.

5. The method of claim 1, further comprising mixing a second additive with the mixture.

6. The method of claim 5, wherein the second additive comprises at least one additive selected from the group consisting of: a solid additive, a treatment additive, a coated particle, a filler material, a liquid, a gas, and any derivative thereof

7. The method of claim 1, wherein the soft material comprises at least one material selected from the group consisting of: a PLA, a guar, an aliphatic polyester, a degradable material, a thermoplastic material, a vinyl polymer, a polyvinyl alcohol, a polysaccharide, a cork, a rubber, a fiberboard, and any derivative thereof.

8. The method of claim 1, further comprising introducing the ultrafine particles into a portion of a subterranean formation.

9. A method comprising:
providing a soft material;
raising the temperature of the soft material to at least the glass transition temperature of the soft material;
cooling the temperature of the soft material while stressing the soft material; and
grinding the soft material to form ultrafine particles.

10. The method of claim 9, further comprising stressing the mixture during the step of raising the temperature of the soft material to at least the glass transition temperature of the soft material.

11. The method of claim 9, further comprising mixing an additive with the soft material, wherein the additive comprises at least one additive selected from the group consisting of: a solid additive, a treatment additive, a coated particle, a filler material, a liquid, a gas, and any derivative thereof.

12. The method of claim 9, wherein the soft material comprises at least one material selected from the group consisting of: a PLA, a guar, an aliphatic polyester, a degradable material, a thermoplastic material, a vinyl polymer, a polyvinyl alcohol, a polysaccharide, a cork, a rubber, a fiberboard, and any derivative thereof.

13. The method of claim 9, further comprising introducing the ultrafine particles into a portion of a subterranean formation.

14. A method comprising:
mixing a soft material with a treatment additive to form a mixture;
raising the temperature of the mixture to at least the glass transition temperature of the soft material;
cooling the temperature of the mixture; and
grinding the mixture to form ultrafine particles that comprise at least a portion of the soft material, whereby at least a portion of the treatment additive is at least partially coated by some portion of the soft material.

15. The method of claim 14, further comprising stressing the mixture during the step of raising the temperature of the mixture to at least the glass transition temperature of the soft material.

16. The method of claim 14, further comprising stressing the mixture during the step of cooling the temperature of the mixture.

17. The method of claim 14, further comprising adding a second additive to the mixture.

18. The method of claim 17, wherein the second additive comprises at least one additive selected from the group consisting of a solid additive, a second treatment additive, a coated particle, a filler material, a liquid, a gas, and any derivative thereof

19. The method of claim 14, wherein the soft material comprises at least one material //selected from the group consisting of a PLA, a guar, an aliphatic polyester, a degradable material, a thermoplastic material, a vinyl polymer, a polyvinyl alcohol, a polysaccharide, a cork, a rubber, a fiberboard, and any derivative thereof.

20. The method of claim 14, further comprising introducing the ultrafine particles into a portion of a subterranean formation.
